(19) United States
(12) Patent Application Publication
(10) Pub. No.: US 2012/0241564 A1
(43) Pub. Date: Sep. 27, 2012

(54) SLAT SUPPORT ASSEMBLY

(76) Inventor: Simon John Parker, Bristol (GB)

(21) Appl. No.: 13/514,921

(22) PCT Filed: Dec. 6, 2010
(86) PCT No.: PCT/GB2010/052027

§ 371 Date: Jun. 8, 2012

(30) Foreign Application Priority Data
Dec. 8, 2009 (GB) 0921487.5

(51) Int. Cl. B64C 9/24

(52) U.S. Cl. 244/214

(57) ABSTRACT

A slat support assembly is disclosed. It comprises a slat support arm having a toothed rack (10), the slat support arm being movable to deploy a slat attached to one end of said slat support arm from a leading edge of an aircraft wing and, a pinion (11) having teeth that cooperate with the rack so that the slat moves in response to actuation of a rotary actuator coupled to the pinion. The cooperating teeth (13,14) are helical in shape.

The present invention relates to a support assembly for supporting the slats on the leading edge of an aircraft wing. The invention also relates to an aircraft wing comprising at least one slat attached to a leading edge of the wing using the support assembly of the invention.

### BACKGROUND

Aircraft need to produce varying levels of lift for take-off, landing and cruise. A combination of wing leading and trailing edge devices are used to control the wing coefficient of lift. The leading edge device is known as a slat. On larger aircraft there may be several slats spaced along the wing edge. During normal flight the slats are retracted against the leading edge of the wing. However, during take-off and landing they are deployed forwardly of the wing so as to vary the airflow across and under the wing surfaces. The slats usually follow an arcuate or curved path between their stowed and deployed positions. By varying the extent to which the slat is deployed along said path, the lift provided by the wing can be controlled.

An assembly is required to support and guide movement of a slat between stowed and deployed positions and a typical arrangement showing a cross-section through part of a wing 1 and a slat 2 in its stowed position is illustrated in FIG. 1. As can be seen from FIG. 1, the slat 2 is provided with an arcuate support arm or slat track 3 one end 4 of which is rigidly attached to the rear of the slat 2 and extends into the wing 1. The slat track 3 penetrates wing spar 6 forming the wing structure. The slat track 3 defines an arc having an axis and is mounted within the wing so that it can rotate about that axis (in the direction indicated by arrows “A” and “B” in FIG. 1) to deploy and retract the slat 2 attached to one end of the slat track 3.

To drive the slat rack 3 so as to deploy or retract the slat 2, a toothed slat rack 7 having an arcuate shape corresponding to the arcuate shape of the slat track 3 is mounted within a recess 3a on the slat track 3 and a correspondingly toothed drive pinion 8 is in engagement with the teeth 7a on the slat rack 7 so that when the drive pinion 8 rotates, the teeth 8a on the drive pinion 8 and the teeth 7a on the rack 7 cooperate to pivot or drive the slat rack 7 and the slat attached thereto, into a deployed position, i.e. in the direction of arrow “A” in FIG. 1. Typically, the slat track 3 rotates through an angle of 27 degrees between its fully stowed and fully deployed positions. Rotation of the pinion 8 in the opposite direction also drives the slat track 3, in the direction of arrow “B”, back into its stowed position, as shown in FIG. 1.

The drive pinion 8 is mounted on a shaft 9 that extends along, and within, the leading edge of the wing 1. Several gears 8 maybe rotatably mounted on the shaft 8, one for driving each slat 2 so that when the shaft 9 is rotated by a slat deployment motor close to the inboard end of the wing 1, all the slats are deployed together, although it is also possible to provide individual actuators per slat track so that the slats are each deployed separately.

It will be noted that the teeth 7a on the slat track are straight cut and the drive pinion 8 has a spur or involute gear tooth form so that the edges of the teeth are parallel to the axis of rotation. However, this has been found to give a ‘lumpy’ and noisy movement and also results in considerable backlash. This backlash causes vibration and directly affects sizing of supporting structures and components thereby increasing the weight of the aircraft. Furthermore, it will be appreciated that when conventional spur gears meet there is a line of contact across their entire width causing impact stress and noise as contact between them is either fully on or fully off. This becomes more apparent in higher speed applications where a characteristic ‘whining’ noise can be heard. As a result of this impact loading, spur gears are unable to withstand very high torque transmission.

The present invention seeks to provide a slat support assembly in which the problems and disadvantages described above have been overcome or alleviated.

### SUMMARY OF THE INVENTION

According to the present invention, there is provided a slat support assembly comprising a slat support arm having a toothed rack attached thereto, the slat support arm being movable to deploy a slat attached to one end of said slat support arm from a leading edge of an aircraft wing, and a pinion having teeth that cooperate with the toothed rack attached to the slat support arm so that the slat support arm moves in response to actuation of a rotary actuator coupled to the pinion, wherein the cooperating teeth are helical in shape.

As the gears take a helically shaped form or profile, the teeth engage more gradually than spur gear teeth resulting in much smoother and quieter running When helical gears mesh with their axes parallel to each other, the helices of a pair of meshing teeth meet at a common tangent and the contact between the tooth surfaces will be a curve extending some distance across their face widths. In more detail, when each pair of teeth first make contact at a single point at one side of the gear wheel, a moving curve of contact gradually grows across the tooth face and may span the entire width of the tooth for a time. Finally, it recedes until the teeth break contact at a single point on the opposite side of the wheel, therefore the loads are introduced and released gradually, rather than instantaneously as is the case with spur gears. As the next Tooth is gradually engaged before the previous tooth is dis-engaged, there is a constant drive—unlike with straight cut spur gears (typically one and a half teeth in constant contact).

Although the use of helical gears results in the presence of thrust loading along the axis of the gear, this can be accommodated by a thrust bearing. Alternatively, if the helical gearing of the present invention is used in combination with the Applicant's own slat track bearing assembly, as described in our previous application No. GB0816022.8, any side or thrust loading can easily be accommodated by the slat track support bearings that are positioned to withstand loading in multiple directions. The present invention also provides an embodiment that employs a double helical gear that can withstand axial loading and which ‘self cancels’ the thrust loading.

In one embodiment, the teeth on the rack and on the pinion each comprise two portions in side-by-side relation, one portion defining a right-handed helix and the other portion defining a left-handed helix.

A gap maybe formed between each tooth portion on the rack and on the pinion, respectively, although it is also envisaged that the teeth maybe formed without any gap between the portions.

In one embodiment, the teeth on each portion in side-by-side relation are in alignment in an axial direction so that the tip of each tooth on one portion is aligned with the tip of a corresponding tooth on its adjacent portion

In another embodiment, the teeth on each portion in side-by-side relation are staggered so that the tip of each tooth on one portion is aligned with a trough between teeth on its adjacent portion.

Preferably, the slat support arm and, the slat track rack, are curved in shape. However, it is envisaged that the slat support arm and rack could be linear or take some other shape or formation.

The material properties of the slat track and rack areo are preferably different so that the high tooth pressure experienced by the rack can be withstood whilst at the same time allowing for a degree of flexibility in the track

The slat support assembly may comprise a groove in the slat support arm, the slat track rack being mounted to the slat support arm in the groove for cooperation with a drive pinion configured to rotate the slat track about its axis for deployment and retraction of the slat.

It is envisaged that the rack together with the track could be made together as a singe piece.

According to the invention, there is also provided an aircraft wing including a slat support assembly according to the invention.

### DESCRIPTION OF THE DRAWINGS

Embodiments of the invention will now be described, by way of example only, and with reference to FIGS. 2 to 5 of the accompanying drawings, in which:

FIG. 1 is a prior art side sectional view through a portion of a leading-edge of a wing of an aircraft with a slat shown in its stowed position;

FIG. 2 is a perspective view of a portion of a toothed slat track rack and slat track drive pinion according to a first embodiment of the invention, with the cooperating teeth of the rack and pinion being helical in shape;

FIG. 3 is an enlarged side view of a portion of the toothed slat rack and slat track drive pinion shown in FIG. 2;

FIG. 4 is a perspective view of a portion of a toothed slat track rack and slat track drive pinion according to a second embodiment of the invention; and

FIG. 5 is an enlarged side view of a portion of the toothed slat rack and slat drive pinion shown in FIG. 4;

### DESCRIPTION OF THE PREFERRED EMBODIMENTS

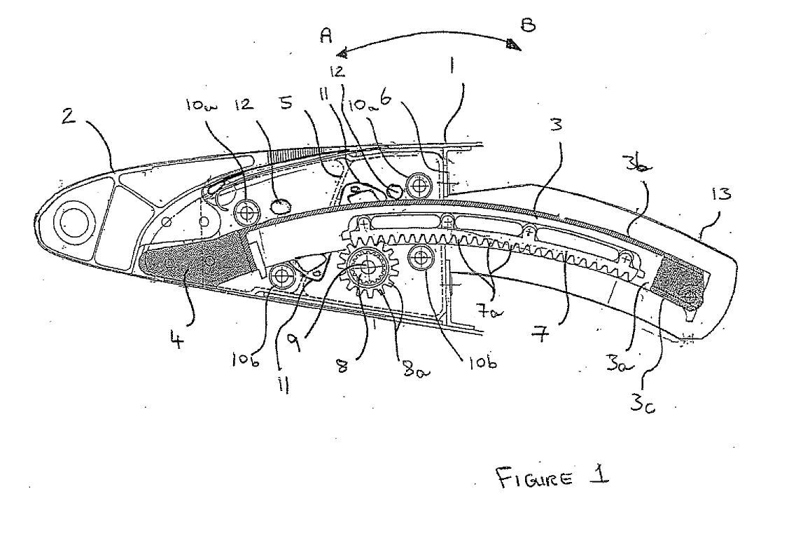

FIG. 1 represents a prior art view of a portion of a leading edge of a wing and slat track assembly that has already been described above.

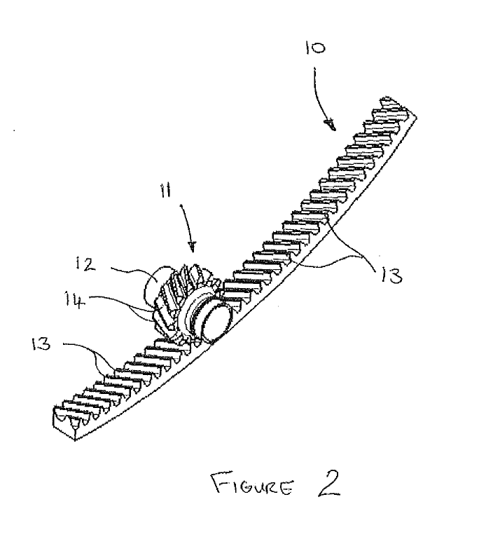

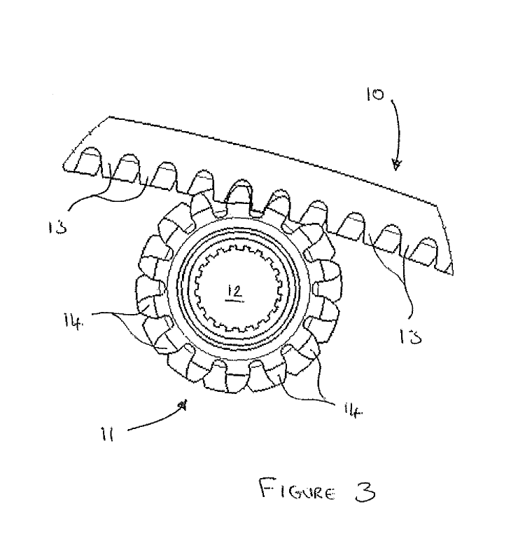

Referring initially to FIGS. 2 and 3 of the accompanying drawings, there is shown part of a curved slat track rack 10 for rigid attachment to a slat support arm (not shown). The slat track rack 10 is drivingly engaged by a pinion 11 mounted on a shaft 12 for rotation together with said shaft 12. The rack 10 is formed with a helically shaped tooth profile 13 that meshes with a correspondingly shaped helical tooth profile 14 formed on the pinion 11. The shaft 12 is coupled to a rotary actuator such as a motor (not shown) to rotate the pinion 11 and thereby drive the slat support arm in the direction of arrow ‘A’ or ‘B’ (see FIG. 1) depending on the direction of rotation of the pinion 11.

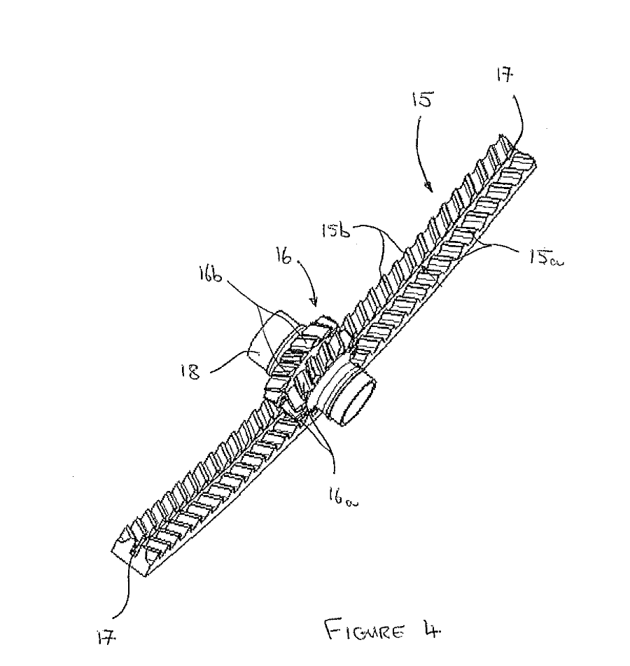

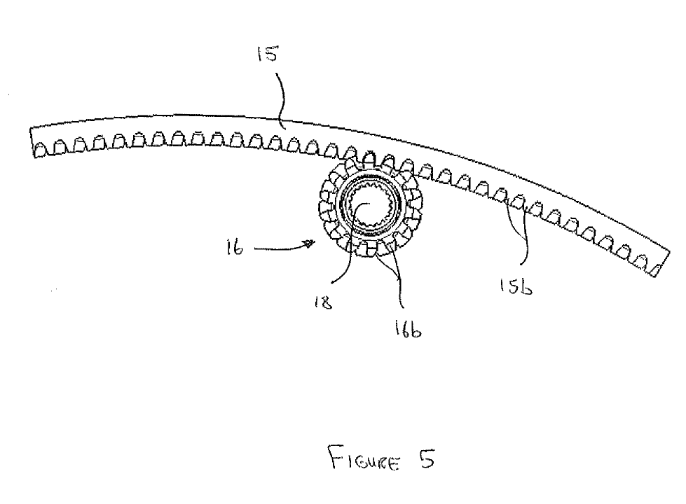

Referring now to the second embodiment shown in FIGS. 4 and 5, it can be seen that the slat track rack 15 is now provided with a double helical or herringbone gear profile in which the teeth are split into two portions 15a, 15b, one half extending on a right-handed helix and the other half extending on a left-handed helix so they assume a V-shaped profile. Similarly, the pinion 16 is provided with a double helical or herringbone gear profile having one portion extending on a right handed helix 16a and the other portion extending on a left handed helix 16b corresponding to the gear profile of the toothed rack 15. This configuration is advantageous as the assembly can withstand side loading in either axial direction as the loads cancel each other out. This is not possible with single helical gearing such as that described with reference to FIGS. 2 and 3.

As can be seen in FIGS. 4 and 5, each portion of the teeth 15a,15b on the rack 15 and on the pinion 16 are separated by a gap or channel 17. This is to faciliate machining of the gear teeth to allow the tool to run out between the teeth portions 15a, 15b. However, it is envisaged that it is possible to make the oppositely angled teeth 15a,15b continuous without any gaps. It would also be possible to form each portion of the slat track rack 15 separately and then attach them together or to the slat track arm so that the teeth 15a,15b are contiguous. Similarly, ′) each toothed portion 16a,16b of the pinion 16 can be formed of two separate parts which are separately mounted side-by-side on the drive shaft 18.

Although each of the helical gear portions 15a,15b; 16a, 16b on the rack 15, and on the pinion 16, maybe a mirror image of each other so that the tips of the teeth of one portion are in alignment with corresponding tips of the teeth on its adjacent portion, it is also possible for each helical gear portion 15a,15b; 16a,16b to be staggered or out of phase with each other so that the tips of the teeth of one portion correspond with the troughs of the teeth on its adjacent portion.

Although reference is made to a curved slat rack 15, which is attached to a curved slat support arm for deployment in a circular arc, it is also envisaged that the slat support arm could follow a non-circular path such as an elliptical or linear path and/or that the slat support arm may not be curved.

It will be appreciated that the above description refers to only two embodiments and that other embodiments falling within the scope of the appended claims are also considered to form part of the invention.

1. A slat support assembly comprising a slat support arm having a toothed rack attached thereto, the slat support arm being movable to deploy a slat attached to said slat support arm from a leading edge of an aircraft wing, and a pinion having teeth that cooperate with the toothed rack attached to the slat support arm so that the slat support arm moves in response to actuation of a rotary actuator coupled to the pinion, wherein the cooperating teeth are helical in shape, wherein the teeth on the rack and on the pinion each comprise two portions in side-by-side relation, wherein one portion defines a right-handed helix and the other portion defines a left-handed helix and the teeth on each portion are staggered so that the tip of each tooth on one portion is aligned with a trough between teeth on its adjacent portion.

2. (canceled)

3. A slat support assembly according to claim 1, comprising a gap between each tooth portion on the rack and on the pinion, respectively.

4. A slat support assembly according to claim 1, wherein the teeth on each portion in side-by-side relation are in alignment in an axial direction so that the tip of each tooth on one portion is aligned with the tip of a corresponding tooth on its adjacent portion.

5. (canceled)

6. A slat support assembly according to claim 1, wherein the slat support arm is curved in shape.

7. A slat support assembly according to claim 1, wherein the toothed rack is fixedly attached to the slat support arm.

8. An aircraft wing including a slat support assembly according to claim 1.

9. (canceled)
